(19) United States
(12) Patent Application Publication
(10) Pub. No.: US 2021/0022939 A1
(43) Pub. Date: Jan. 28, 2021

(54) Knee renew

(71) Applicants: Greg A. Ewart, Brentwood, IN (US); Ariana S. Ewart, Brentwood, IN (US)

(72) Inventors: Greg A. Ewart, Brentwood, IN (US); Ariana S. Ewart, Brentwood, IN (US)

(21) Appl. No.: 16/602,031

(22) Filed: Jul. 24, 2019

(51) Int. Cl. A61H 1/02; A63B 23/04

(52) U.S. Cl. CPC A61H 1/024; A63B 23/0494

(57) ABSTRACT

A knee traction/decompression system used for the treatment of knee disorders by effectively applying a desired traction/decompression force to relieve pain, stimulate healing by opening pathways to the knee articulation while maintaining the basic comfort of the patient The system employs a rotational separation of the associated bones of the knee joint via a fulcrum that is positioned between two side rails. The side rails are connected by the end rails which create a stationary platform. An adjustable retracting device containing a cord attached to a strap placed and secured around the foot which is then manually moved relative to the platform. The knee is placed over the fulcrum and the retracting device is pulled in a direction as to allow a traction/decompression force on the knee articulation. The fulcrum action separates the knee articulation by applying a pulling force to the foot harness relative to the platform creating a long lever.

### BACKGROUND OF THE INVENTION

The present invention relates generally to a knee traction/ decompression system wherein traction/decompression is applied to the knee. More specifically, the present invention relates to a knee traction/decompression system for the treatment of knee disorders arising from degenerative processes. The unit employs a metal frame platform with a centrally placed fulcrum allowing a rotational traction/decompression force to be manually applied to relieve pain and stimulate healing by opening the pathways to the soft tissue of the knee articulation while maintaining the basic comfort of the patient.

Traction therapy, also referred to as decompression therapy, is widely used to relieve pressure on inflamed or compressed joints. While traction is applicable to any part of the body, spinal traction is the most common. It is known in the art that spinal traction/decompression therapy has proven beneficial to most patients. When correctly performed, spinal traction can cause distraction or separation of the vertebral bodies, a combination of distraction and gliding of the facet joints, tensing of the ligamentous structures of the spinal segment, widening of the intervertebral foramen, straightening of spinal curvature and stretching of the spinal musculature. To be effective and depending on the injury and/or condition being treated, the traction component of physical therapy may require multiple sessions per week for a prolonged period of time.

To apply effective knee traction/ decompression, a variable force must be applied. However, the problem is that current equipment, providing only axial traction forces are large mechanical units only found in a few therapeutic or research facilities and thus only available to individuals in a few offices, are extremely expensive and not available for continued home care. As a result, most traction/decompression knee systems utilized have, for the most part, been relatively ineffective because patients cannot find or afford the treatments, or must travel to a doctor's office to receive the treatments. Therefore, in most cases, bed rest, general physical therapy and medications are suggested as a means to healing, which in most cases provides only short term relief, requiring extended periods of time in a recumbent (non-weight bearing) position rather than actually applying the desired traction to provide real healing. In addition, the scarce devices that do exist are generally large, cumbersome, standalone units designed for research, not utilized in general outpatient clinics and provide only axial traction.

Attempts to create a sufficiently low cost portable traction device for home use have thus far produced no results. There are a few traction devices utilizing pneumatic or hydraulic cylinders to create the traction force. Most are units designed for other areas of the body and manipulated in such ways as to accommodate the knee. Hydraulic cylinders have the disadvantage of the weight of the hydraulic fluid and the potential for leakage. Those units with pump and sensor configurations are costly, heavy, and too complex for continued home self use. These traction units are usually used only for research studies and in a few larger more aggressive outpatient clinics. These pump and sensor configurations add cost, weight, and complexity to the traction device.

Therefore, there is a need for a low cost, lightweight portable knee traction device utilizing a self-applied rotational traction/decompression force generating apparatus that can maintain a force of an adequate magnitude for a given period of time.

### BRIEF SUMMARY OF THE INVENTION

In this regard, the present invention provides for a knee traction/decompression system for the treatment of knee pain arising from degenerative processes that rotationally separates the femur tibia complex by effectively applying the desired self administered traction and pressure to relieve pain and stimulate healing by opening the pathway to the meniscus while maintaining the basic comfort of the patient.

In contrast to the prior art, the present concept employs rotational separation by means of a centrally placed fulcrum that is positioned within a stationary horizontal support platform. A pulling force is applied via a foot harness attached to a cord and retractable hand held device. As the force is applied, there is a rotational separation of the femur and tibia. Several medical studies indicate that articular cartilage regeneration occurs when a traction force has been applied to the knee joint. To control pressure, the individual is in complete control of the amount of force being applied as well as the duration of the force.

It is therefore an object of the present invention to provide a low cost, lightweight portable traction device utilizing a traction force generated manually that can maintain a traction force of an appropriate magnitude for a given period of time. It is a further object of the present invention to provide a traction/decompression system for the treatment of knee pain arising from degenerative changes or reducing the effects of prolonged compressive forces by effectively applying the desired traction to relieve pain and stimulate healing by opening the pathway to the meniscus while maintaining the basic comfort of the patient.

For a better understanding of the invention, along with various features of novelty which characterize the invention, its operating advantages and the specific objects attained by its uses, reference should be made to the accompanying drawings and descriptive matter in which there is illustrated a preferred embodiment of the invention.

### Drawings Figures

In the drawings, closely related figures have the same number.

FIG. 1 is a lateral perspective view of the entire knee traction device of the present invention.

FIG. 2 is a lateral oblique perspective view of the entire knee traction device of the present invention.

FIG. 3 is a posterior perspective view of the disconnected side rail, end rail, fulcrum and non-skid wrap.

FIG. 4 is a lateral view of the foot harness, cord and hand held retractable device.

Drawings - - - Reference Numerals

| | | | |
|---|---|---|---|
| 11 | side rails | 12 | fulcrum |
| 13 | soft compressive wrap | 14 | plastic fulcrum core |
| 15 | connecting bolt | 16 | side rail adjustment holes |
| 17 | end rails | 18 | non-skid wrap |

### DETAILED DESCRIPTION OF THE INVENTION

The drawings illustrate the knee traction/decompression system for the treatment of knee back pain arising from degenerative or compressive forces. The unit rotationally separates the femoral tibial joint by creating a lever effectively applying the desired traction to relieve pain and stimulate healing by opening the pathway to the meniscus and articular cartilage while maintaining the basic comfort of the patient. This is generally illustrated in the figures shown below.

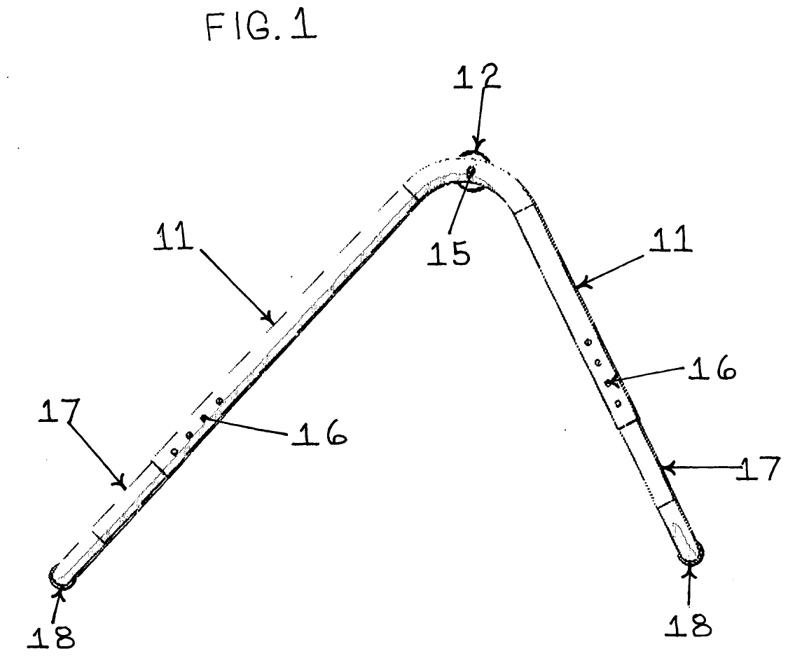

FIG. 1, the components of the knee traction system FIG. 1 are tubular metal side rails 11 at an angle of 70 degrees. The side rails 11 extend telescopically over the end rails 17 in order to accommodate different femur heights. A central positioned fulcrum 12, connected to the side rails via a bolt 15, acts as a pivot point around which the knee joint is tractioned. The side rails 11 contain several adjusting holes 6 with snap clips to hold the side rail 11/end rail 17 at a given height.

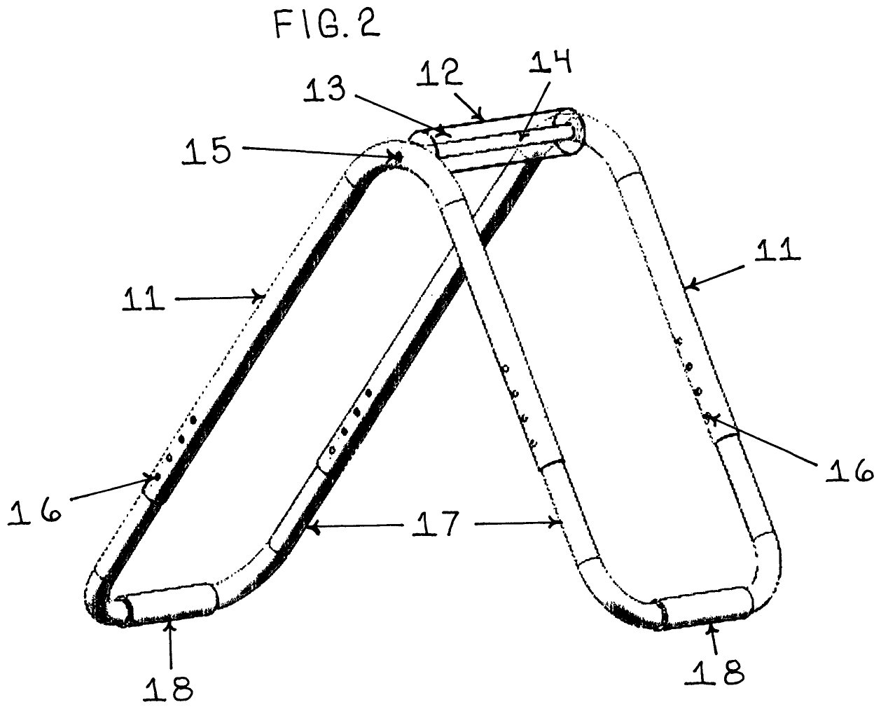

FIG. 2 The fulcrum consists of a central plastic core 14 which houses the connecting bolt 15 and is covered with an outer soft foam 13. The distal end of the end rails are covered with an anti skid rubberized material 18.

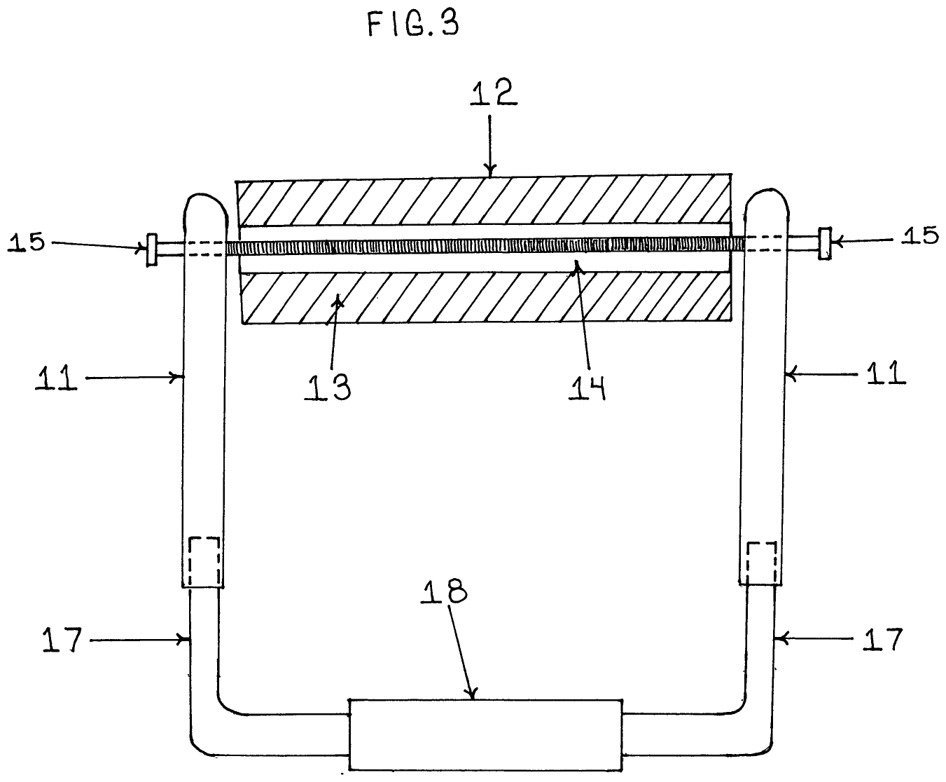

FIG. 3 A foot harness 10 made out of common elastic material is secured to the foot and a simple cord 11 is attached to a common hand held retractable device 12.

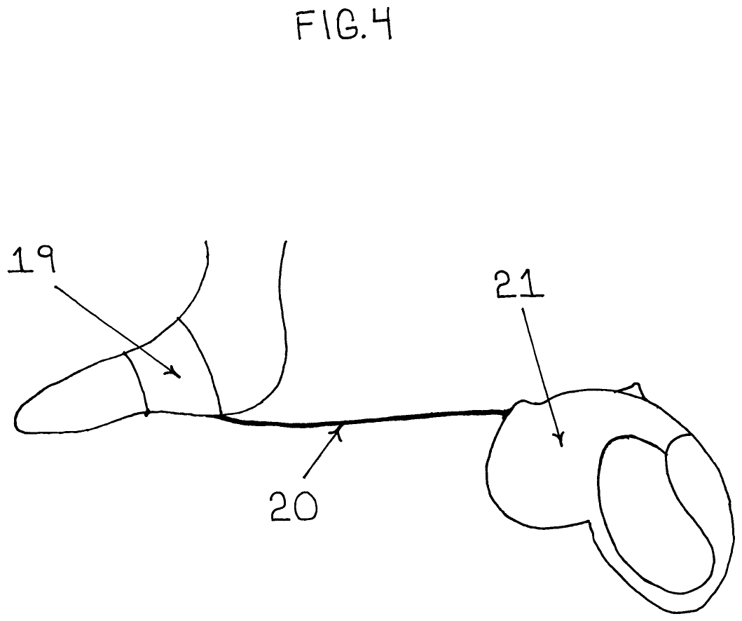

FIG. 4 A lateral view of the foot harness, cord and hand held retractable device.

### OPERATION

The body of the subject lies supine on a flat stable surface. The user secures the foot harness around the foot. The popliteal fossa is then extended over the fulcrum of the traction unit. Subject then uses the retractable hand held device, initiating a pulling effect on the foot creating a lever around the femoral tibial joint (pivot point). This movement creates a traction/decompression action on the knee joint.

We claim:

1. A system for applying traction to the knee, comprising:
a frame for supporting the knee;
a bolt connecting the side rails;
a bolt that houses the fulcrum;
a foot wrap connected by a cord to a hand held device.

2. The system of claim 1, wherein two side rails connected to two end rails telescopically.

3. The system of claim 1, wherein the end rails are wrapped in a non-skid material.

4. The system of claim 1, wherein the side rails and end rails contain holes with adjusting pins.

5. The system of claim 1, wherein a connecting bolt is attached to the two side rails.

6. The system of claim 1, wherein the connecting bolt is wrapped by a plastic material.

7. The system of claim 1, wherein the plastic core is wrapped by a soft compressive material.

8. The system of claim 1, wherein a foot wrap is attached by a cord to a hand held device.
